(19) United States
(12) Patent Application Publication
(10) Pub. No.: US 2007/0083823 A1
(43) Pub. Date: Apr. 12, 2007

(54) Scroll bar for computer display

(76) Inventor: Denny Jaeger, Oakland, CA (US)

Correspondence Address: ZIMMERMAN & CRONEN, LLP, 1330 BROADWAY, SUITE 710, OAKLAND, CA, 94612-2506, US

(21) Appl. No.: 11/516,428

(22) Filed: Sep. 5, 2006

Related U.S. Application Data
(63) Continuation-in-part of application No. 10/188,625, filed on Jul. 1, 2002, now Pat. No. 7,103,851.
Application No. 10/188,625 is a continuation-in-part of application No. 09/880,397, filed on Jun. 12, 2001, now Pat. No. 6,883,145.
Application No. 09/880,397 is a continuation-in-part of application No. 09/785,049, filed on Feb. 15, 2001.

(51) Int. Cl. G06F 17/00

(52) U.S. Cl. 715/787

(57) ABSTRACT

An improved scroll bar arrangement for a window (canvas) displayed on a computer screen includes a computer display canvas comprised of a wire frame and a scroll button (fader cap) at a side edge and/or bottom edge of the canvas. The fader cap is actuated to place scroller markers at the edge of the wire frame; each scroller marker may be activated to print the respective display at the position of the scroller marker. Scroller markers may receive assignments from within the wire frame, or from onscreen objects outside the wire frame.

### CROSS-REFERENCE TO RELATED APPLICATIONS

This application is a continuation-in-part of U.S. patent application Ser. No. 10/188,625, filed Jul. 1, 2002, which is a continuation-in-part of U.S. patent application Ser. No. 09/880,397, filed Jun. 12, 2001, which is a continuation-in-part of U.S. patent application Ser. No. 09/785,049, filed Feb. 15, 2001, for which priority is claimed. The entireties of the prior applications are incorporated herein by reference.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to computer displays and, more particularly, to scroll bar devices employed to view displayed objects.

2. Description of Related Art

Given the fact that the graphic user interface for computers and the like has been in use for less than two decades, it is somewhat surprising that so many of the common furnishings of the most popular graphic interfaces have become so familiar. Indeed, features such as pulldown menus and a window for each program or document that is open, are tools that computer users expect to be provided in any commercial application.

In a general sense, a window displayed in a graphical user interface is a rectangular display space bounded by a border. Typically, the size of the window may be altered by dragging one corner inwardly or outwardly, or clicking on marquee button that shrinks or expands the window size. When the window display space is smaller than the document or object it is displaying, it is typical for a window to automatically provide a scroll bar. The scroll bar is comprised of a narrow rectangular box extending vertically and/or horizontally at the edge of the window, and a smaller rectangular “button” disposed in the box and adapted to be clicked and dragged longitudinally along the narrow box, in the manner of a slider button constrained in a channel or track. The length of the track represents the entire length (or width) of the thing being displayed, and the position of the button on the track provides an intuitive indication of the portion of the thing that is currently displayed in the window.

Consumer demand has led to the introduction of enhancements to the scroll bar concept. Up and down arrows at one or both ends of each scroll track can be used to scroll incrementally (line-by-line, for example), and a mouse scroll wheel enables rolling/scrolling motion by the user when the mouse cursor is on the track. Also, some applications employ a scaled size scroll button, in which the longitudinal dimension of the button is approximately proportioned to the ratio of the window display length (or width) to the length (or width) of the thing being displayed. These features enable the user to assert precise control of the scrolling process.

Aside from micro-control of scrolling, another problem presented by scroll bars involves navigation within a document, particularly a large document. For example, a word processing document may have tens or hundreds of pages, and editing such a document may require cutting and pasting throughout the document, style changes or rewriting at designated places, and the like. Marking, finding, and keeping track of locations within a large document are tasks that scroll bar embodiments known in the prior art are not designed to carry out. In some applications, dragging the scroll button causes an adjacent box to display the current page number, so that the user may know how far to drag the button to arrive at a particular page. However, the user must rely on other external organizing tools to be efficient in editing or revising a large document.

As noted above, every scroll bar includes an opaque track on which the scroll button is slidable. Thus each window presented onscreen includes opaque margins at the bottom and sides that are approximately ¼ inch (0.6 cm) wide, obscuring a small but not insubstantial portion of the display. When several windows are presented onscreen, the reduction in object display area caused by the sum total area of the scroll bars of the windows may become significant. It is desirable to reduce this waste of display space, if possible.

### BRIEF SUMMARY OF THE INVENTION

The present invention generally comprises an improved scroll bar arrangement for a window displayed on a computer display or the like. Salient aspects of the invention are that it occupies an absolute minimum of onscreen display space, and that it provides a simple arrangement for navigating through a document exhibited in a window.

In order to avoid confusion with previous understandings of the term “window” as it applies to the display arts, and to prevent any misunderstanding regarding trademarks that include the term “window,” hereinafter a bounded area within an electronic display space for exhibiting a document or item will be termed a “canvas.”

The scroll bar arrangement includes a computer display canvas comprised of a wire frame, rather than the prior art style that includes a wide border at the margin. In addition, a scroll button is provided at a side edge and/or bottom edge of the canvas, the scroll button comprised of a rectangular box having a transparent center, so that onscreen objects behind the canvas are visualizable through the portion of the scroll button that extends outwardly from the canvas edge. The scroll button is constrained to translate along the respective edge of the canvas, in the manner of a fader controller, and hereinafter will be termed a fader cap.

The fader cap may be dragged along its respective side of the canvas to move the document through the canvas in typical scrolling fashion. The dragging technique may comprise any such technique known in the prior art, such as click-and-drag, touch-and-drag on a touch screen, and the like. The position of the fader cap along its edge is related to a ratio of the position of the portion of the document being displayed, to the total length (or width) of the document.

The invention also provides a navigation aide to assist a user in noting any portion of the document for future access. The fader cap includes a line extending medially through the rectangular box perpendicular to the edge of the canvas. The fader cap may be dragged to any point along its edge of the canvas (or the document may be advanced by other means, such as incremental advances), and the medial line of the fader cap may be double clicked (or the like) to cause a marker bar to be displayed on the edge of the canvas at the position of the medial line of the fader cap. This process may be repeated as many times as necessary along the edge of the canvas (corresponding to differing locations in the document) to generate a plurality of marker bars along the canvas edge.

Each marker bar may be displayed in a unique color, so that it is easily distinguished from the other marker bars. The user may right-click (or the like) on any marker bar to call forth an Info Canvas display that exhibits detailed data on that particular marker bar. The Info Canvas may include a space for notes entered by the user, so that the portion of the document displayed at that particular marker bar may be identified, and comments may be entered. In addition, the color, assignment, dates of creation and modification, and the like may be recorded. This data is important in enabling the user to edit documents and navigate between different sections of text, portions of a picture file, spreadsheet rows and columns, and the like.

A further aspect of the invention is the ability to select text using the marker bars. A user may lasso or otherwise circumscribe any two marker bars to cause the system to select all of the document that lies between the two markers. Thus, for example, the use may lasso two marker bars to select several pages of text, and then change the font size or style for that selected portion of the document. Likewise, in a spreadsheet display a user may employ lassoed marker bars to select rows and columns of the spreadsheet.

### BRIEF DESCRIPTION OF THE DRAWING

FIG. 1 is a sample text portion used in subsequent figures.

FIG. 2 is a plan view of the canvas and scroll bar arrangement of the present invention, displaying the sample text of FIG. 1.

FIG. 3 is a plan view of the canvas of FIG. 2, showing the fader cap moved to the bottom of the document.

FIGS. 4A-4C depict the steps in placing marker bars along the scroll edge of the canvas.

FIG. 5 is a plan view of a selection technique involving drawing a lasso about two marker bars.

FIG. 6 is a plan view of a marker bar Info Canvas elicited by a right click on any marker bar.

FIGS. 7A-7C depict a plan view of a picture exhibited in a wire frame canvas, and horizontal scrolling to view the entire picture.

FIGS. 8A-8B depict a plan view of a canvas and scroll bar arrangement displaying a text portion, showing techniques for navigation using the scroll cap.

FIG. 9 depicts a plan view of a canvas and scroll cap, showing one technique for page up/down navigation.

FIGS. 10A-10B depict a spreadsheet portion displayed in a canvas with a scroller cap, and the use of marker bars to select columns of the spreadsheet matrix.

FIG. 11 is a plan view of a scroller cap free of any medial line.

FIG. 12 is a plan view of a VDACC with scroller markers set for printing.

FIG. 13 is a plan view of a VDACC with scroller markers, showing a technique for printing selected areas demarcated by respective scroller markers.

FIG. 14 is a plan view of a VDACC with scroller markers, showing a technique for assigning display contents to a scroller marker.

FIG. 15 is a plan view of a VDACC showing a technique for assigning a functional device within the VDACC to a scroller marker.

FIG. 16 is a fragmentary plan view of a VDACC, showing a technique for assigning a graphic object outside the VDACC to a scroller marker of the VDACC.

FIG. 17 is a plan view of a VDACC, showing a technique for assigning a functional object to related data content and then assigning the combination to a scroller marker.

### DETAILED DESCRIPTION OF THE INVENTION

The present invention generally comprises an improved canvas display and scrolling feature for use in a computer display or similar visualized output from any electronic device, from mobile telephones to microwave ovens, and the like.

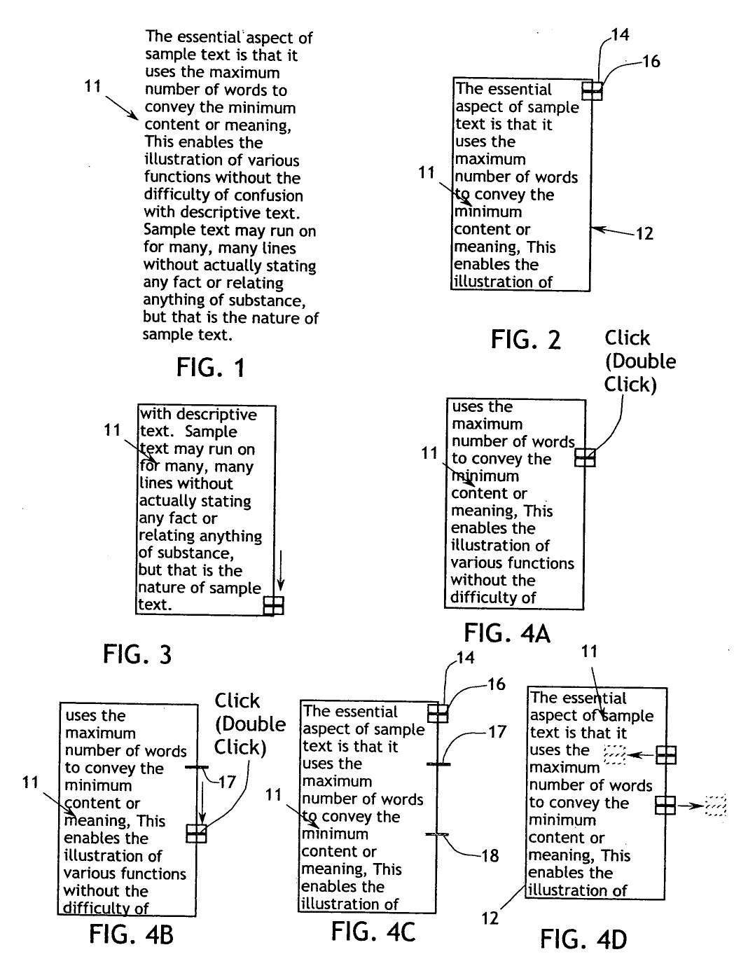

With regard to FIGS. 1 and 2, the invention provides a canvas 12 comprised of a “wire frame,” that is, a rectangular boundary defined by narrow lines. The width of the lines is as small as practical to demarcate the perimeter of the canvas, and may be as small as one pixel wide. It is significant that no scroll tracks or the like are provided at the side or bottom edges of the canvas, so that no display space is obscured by such objects. The canvas 12 may display a text block 11; if the text block is bigger than the canvas, a portion of the text block 11 is displayed in the canvas, and it is necessary to scroll the canvas to view the other portions of the text block document.

To enable scrolling, the invention provides a scrolling control comprised of a fader cap 14 displayed over its respective side (here, the right side) of the canvas 12. The fader cap 14 is constrained to translate along its respective edge of the canvas 12, in the manner of a fader controller. The fader cap 14 may be dragged along its respective side of the canvas to move the document 11 through the canvas in typical scrolling fashion. The position of the fader cap 14 along its side edge is related to a ratio of the position of the portion of the document being displayed, to the total length (or width) of the document. Thus, as shown in FIG. 3, moving the fader cap 14 downwardly from the position shown in FIG. 2 scrolls the display of the text block toward the bottom of the document. The dragging technique may comprise any such technique known in the prior art, such as click-and-drag, touch-and-drag on a touch screen, click-and-scroll using a scrolling mouse, and the like.

The fader cap 14 is comprised of a rectangular or square box having a minimal line width and no fill, so that the interior of the cap 14 is transparent. Thus any portion of the document displayed in canvas 12 that is located beneath the interior of cap 14 is visible. Likewise, any onscreen object or item that is located beneath the exterior of cap 14 is also visible. Thus the fader cap 14, like the wire frame canvas 12, obscures the minimal amount of display space on the screen.

The scroll bar invention includes a navigation aid to assist the user in labeling any selected portion of the document that is displayed in the canvas 12. The fader cap 14 includes a line 16 extending medially through the rectangular box perpendicular to the edge of the canvas. The line 16 may be portrayed in a bright color (here, red) in part to draw visual attention to the fader cap 14. The line 16 is designated as a switch; at any position of the cap 14 along its respective side of the canvas 12, the line 16 may be double-clicked (or the like), as shown in FIG. 4A, to create a marker bar 17. The marker bar is a line that indicates the position of the fader cap 14 when a portion of the document being displayed is selected by the user to be denoted. After a marker bar is created by the user, the user may return to that exact place in the document by merely clicking on the marker bar. Alternatively, the user may return to a place demarcated by a marker bar by dragging the fader cap along its canvas edge to the place where the line 16 overlays the marker bar. Any number of marker bars may be created at any location along the side of the canvas, and may be created in any order and at any time the canvas is open. Thus, as shown in FIGS. 4B and 4C, a second marker bar 18 may be created by the user, and subsequent marker bars, as required.

The marker bars may be differentiated by being displayed in respective unique colors. Thus, as shown in FIGS. 4B and 4C, 5, and 6, the marker bar 17 may be blue, the marker bar 18 may be orange, and so on. With regard to FIG. 6, the user may right click (or the like) on any marker bar to evoke an Info Canvas that displays data regarding the respective marker bar. Such data may include, for example, a “Notes” section where the user may label the location and enter data that is meaningful for editing, rewriting, revising, and the like. The data may also include data regarding date of creation and modification, color, assignment, and the like. All of this date enables the user to fully identify the importance and utility of each marker bar.

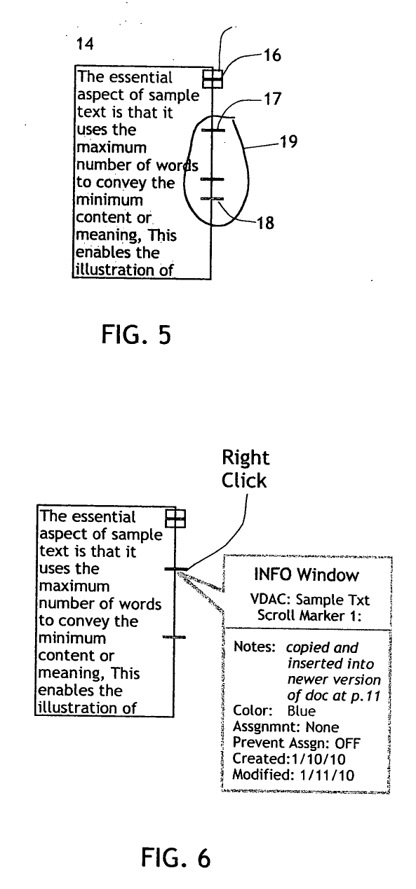

With regard to FIG. 5, marker bars of this invention may also be used to select text or, in general, any portion of a document displayed in canvas 12. A user may draw a lasso 19 (or any other closed curved shape that is designated within the line/arrow logic system to convey this transaction) over the scroll side of the canvas 12, the lasso 19 encompassing at least two marker bars. The system determines the two marker bars that are farthest apart within the lasso 19 area, and selects the document portion extending between these two farthest-spaced marker bars. Thereafter the selected text (that is, selected portion, in general) may be operated upon, as by changing the color or size or style or font of the text, for example. The portion may be deselected by clicking anywhere within the canvas 12, and the lasso 19 will likewise disappear.

With regard to FIG. 6, each marker bar may have attributes and notes that enhance its value to the user as a marker. The user may place the cursor on a selected marker bar, and right click (or the like) to call forth an Info Canvas for the selected marker bar. The Info Canvas provides detailed data on the marker bar, including name, color, assignment status, and created/modified data. An important feature is a Notes portion that enables the user to notate a marker with whatever information is relevant. Thus the document displayed at any marker bar position may be identified, and the reason for denoting that particular portion of the document may be recorded. This data is important in enabling the user to edit documents and navigate between different sections of text, portions of a picture file, spreadsheet rows and columns, and the like. This feature is a great convenience for editing purposes, particularly for long or large documents.

With regard to FIGS. 8A and 8B, there is illustrated a further feature of the scrolling arrangement of the invention. A user may click on the side of the wire frame 12 to which the fader cap 14 is conjoined. The location of the click, particularly the ratio of the distances between the top and bottom of the wire frame 12, is used to change the display to a portion of the document that is located at substantially the same ratio between the beginning and end of the document (FIG. 8B). This display change takes place substantially instantaneously, so that the display appears to jump to the new location in the document. Thus it is not necessary for a user to scroll through a long segment of a document to arrive at a desired section of the document.

With regard to FIG. 9, the invention may provide page up and page down controls. Using arrow logic techniques described in a previous related patent application U.S. patent application Ser. No. 09/880,397, filed Jun. 12, 2001, a user may designate page up/down controls. For example, the user may write or type “page up” in a space adjacent to the wire frame 12, and draw an arrow from the “page up” text to the top half of the scroller fader cap 14. The arrow head will be illuminated or will flash, and the user may then touch the arrow head with the touch pen or with a cursor click. The “page up” text and the arrow will disappear, and the upper half of the fader cap 14 is thereafter a page up control that is activated by a mouse click or pen tap or the like. Likewise, a page down feature may be created by writing or tying “page down” adjacent to the canvas, and drawing an arrow to the lower half of the fader cap 14.

With regard to FIGS. 7A-7C, the fader cap arrangement of the invention may also be employed along a horizontal side of a wire frame canvas 12. Assuming that a picture or graphic 21 is placed into canvas 12, and that the graphic 21 is larger in width than the canvas 12, the canvas will automatically acquire a scroller fader cap 14′ at the lower side of the canvas 12, and a portion of the graphic 21 will be displayed. The fader cap 14′ is provided with a medial line or bar 16′ extending perpendicularly to the lower side of the canvas 12. As shown in FIG. 7C, the fader cap 14′ may be dragged to the right to scroll the display to show the remainder of the graphic 21.

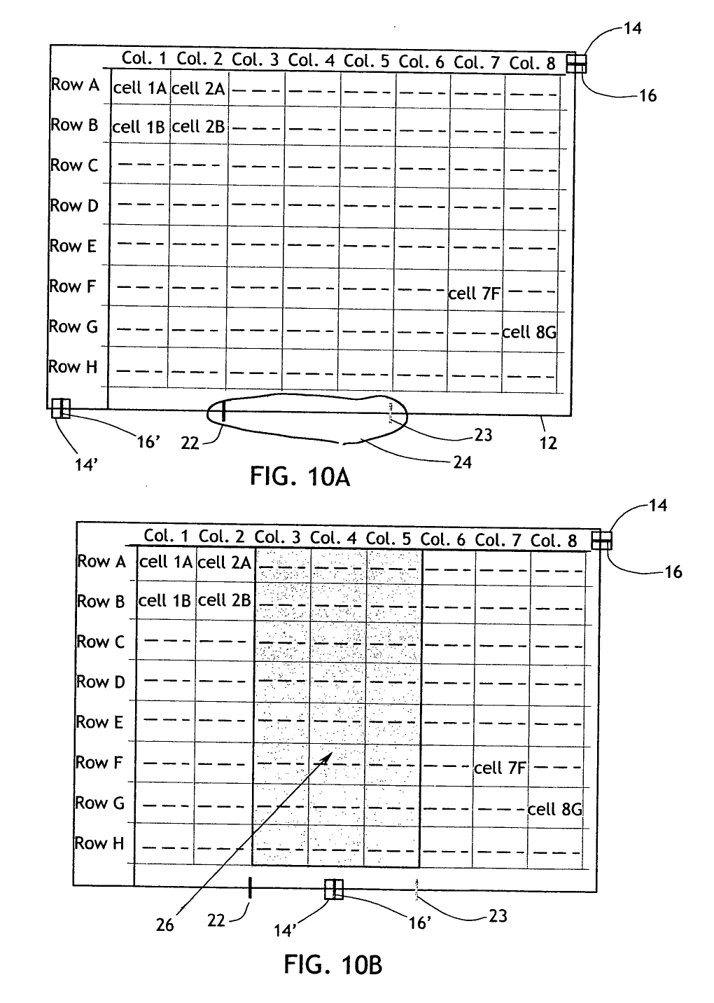

The fader cap 14′ and medial line 16′ are capable of all the functions described above with regard to fader cap 14 and medial line 16. For example, as shown in FIG. 10A, a spreadsheet may be displayed in the canvas 12. Marker bars may be placed at any point along the horizontal edge of the canvas 12, such as marker bars 22 and 23. Each has a distinctive color, and a single click or tap on any marker bar will move the display to the corresponding point in the lateral extent of the document. Likewise, the Info canvas feature is available for these marker bars. A user may select a portion of the lateral extent of the spreadsheet by drawing a lasso 24 about the marker bars 22 and 23. The display immediately jumps to the selected spreadsheet portion, and highlights the lateral extent (all the columns) 26 between the marker bars 22 and 23, as shown in FIG. 10B. Likewise, horizontally extending rows may be selected using marker bars and a lasso on the vertical edge of the canvas 12, as explained previously. This feature greatly simplifies the otherwise complex editing that may be undertaken within a spreadsheet application.

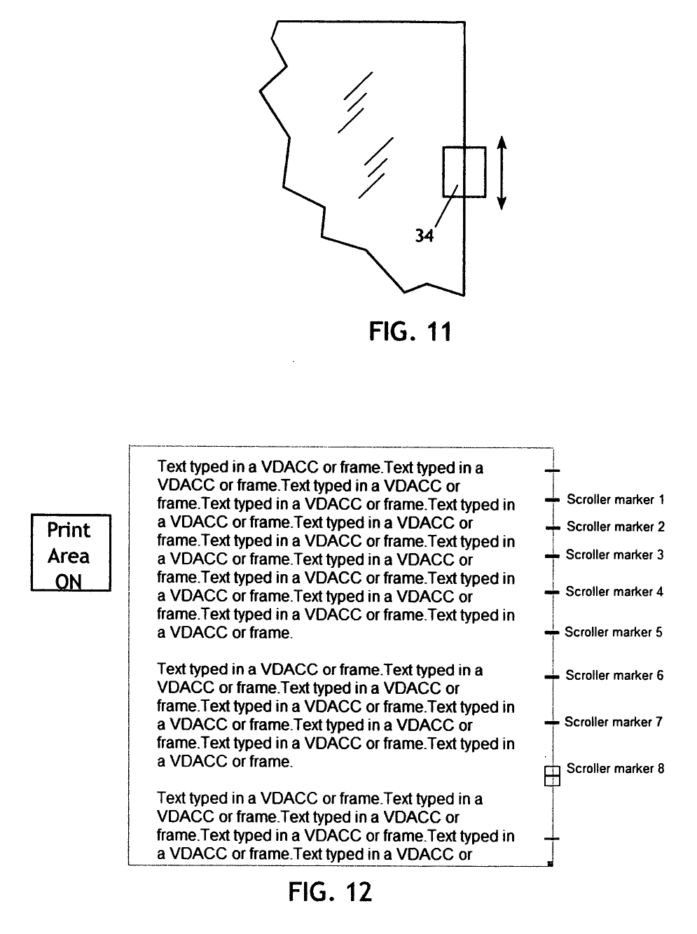

The fader cap concept of the present invention may be extended to encompass any type, style, size, shape, or color of fader cap known in the prior art of display objects and mechanical fader devices. For example, as shown in FIG. 11, the fader cap 34 may comprise a simple rectangle or square that is free of any medial line or the like. A user may double click on any part of the scroller cap 34 to place a scroller marker along the edge of the VDACC, window, picture, or the like.

One advantage of using a VDACC (or its equivalent) with scroller markers is that a user can work in a scrollable environment, like a Web frame, that has no defined pages or area limits. There is no requirement for top and bottom page margins because there is no requirement at all for delineation of pages. It is a free environment in which to organize text and graphical data and content, and the like, as a user chooses. However, when a user wishes to print any portion of the vertical or horizontal flow of information, the user may define any part or parts of the information as pages by using scroller markers. For example, a user may create a personal journal or other confidential document in a VDACC or frame. Some parts of the text are very private, but the user may wish to print to share other parts with others or to keep some portions as printed pages for later use or reference. The user may scroll up or down through the VDACC or frame until a portion is displayed that the user wishes to print.

With regard to FIG. 12, the user then turns on the Print Area function, as described in copending U.S. application Ser. No. xx/xxx,xxx, filed xx/xx/xxxx. Thus the VDACC has a Print Area active for it. Thereafter the user scrolls up or down through the contents until he/she sees at the top of the VDACC that which is desired to be at the top of the printed page. A scroller marker is placed at this position of the scroller cap. The user may scroll through the document and place more scroller markers, and each one will designate a respective area of information to be printed.

The software demarcates the information that is visible in the VDACC at the point where the scroller marker is placed. The information can be placed on the printed page in many ways, depending on the settings in the software. One method is to set the distance from the top of the demarcated information to the top of the VDACC equal to the distance from the top of the information to the top of the printed page. Other default styles and settings may be applied. The bottom of the printed page would be determined thus. Whatever size page has been selected, e.g., 8½″×11″ or 11″×17″ is used to calculate the bottom of the page. So, let's say the 8½″×11″ has been selected as the page size. This would simply be selected in a menu of some kind or it could be invoked by drawing an object that represents this page size or by a verbal command, etc. The software starts of the top of the VDACC with the information located on it as determined by the scroller marker position and then calculate a distance of 11 inches for an 8½″×11″ inch selected paper size. So eleven inches from the top of the VDACC at the location of the scroller marker is the bottom of the page for that scroller marker.

The software may indicate the page bottom to the user in any of several different ways. It may draw a line, for instance, horizontally across the VDACC to indicate the bottom of the page. This line may be a different color to indicate a page bottom. Alternatively, the software may highlight the contents of the page by, for example, creating a slightly darkened background or lightened background if the page is a dark background. In this case the bottom of the page would be where the new background ends.

If the bottom of the page cuts through any text or graphics, different choices are possible. One, if the user opts to print as it is, the printer prints these objects partially cut off. Thus any part of them that lie below the bottom of the page are not printed. Another approach is that the user may be alerted by a pop up alert or voice command that one or more objects on the selected page area is not fitting and need to be adjusted.

It should be noted that the user is not confined to a page structure in the sense that a word processor confines them to such a structure. That is, in a typical word processor program each page is formulated at a height and format determined by settings selected in a page setup menu. And printing is usually carried out within a contiguous page range. In this invention the user makes his/her own decisions about which portions of the document will be printed, and those portions may be non-contiguous and disconnected. Each scroller marker commands the printing of the information displayed in the VDACC at the point of the scroller cap when the marker is placed. The user may scroll through the VDACC a distance that could equal tens of pages and then double click to place another scroller marker. Only the portions designated by a scroller marker will be printed.

Another technique for printing user scroller markers is to select Print for the contents of a VDACC by, for example, opening the Info Canvas of the VDACC and selecting the Print option. If scroller markers are present, the software presents a pop up prompt asking the user to select either “Print all” or “Print according to scroller markers”. If the latter is selected, the software looks for the first marker, ascertains the information displayed at that first marker, and performs a page size calculation as described above. The software then iterates through all the markers and repeats this process, thereby producing printed pages of the marker-selected information.

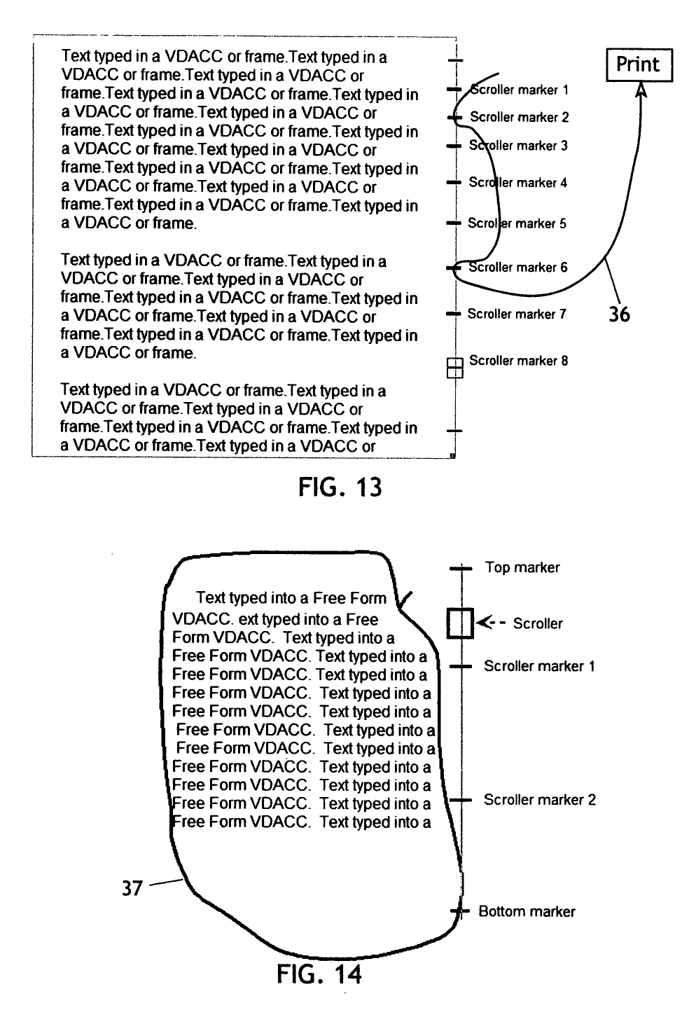

A further technique, shown in FIG. 13, enables printing of only some of the marker-delineated portions of the VDACC contents. The user may place a Print switch on the display by use of a menu or, preferably, voice a command, or place onscreen a Print switch (or any object that represents Printing). The user then draws an arrow through the scroller markers to be printed and extends the arrow to the Print switch. In the example of FIG. 13, markers 2 and 6 are selected for printing, so that the information displayed at the locations of these markers will be printed. After the arrow is drawn the software may indicate recognition of the function by changing color, pulsing, or the like. The user then may click on the arrowhead, or speak a command, and the print action is carried out.

In another printing technique, a user may print different heights or sizes of pages all at once from a single VDACC. The user may designate the amount of vertical space that each scroller marker accounted for. There are many methods for doing this; one method is to right click on each scroller marker and in a menu belonging to that scroller marker make a user entry defining the vertical (or horizontal or both) size of the VDACC area (the content located within this area) that will be printable for that scroller marker. Thus each scroller marker may have a different printable area designated for it. Then when the user prints according to the scroller markers, for instance, the scroller markers with a 6″ height printable area may all be selected (as with a drawn arrow) and used to print on 6″ printed pages. Then the scroller markers with a 11″ page height may be selected, as with a drawn arrow, and then these may be printed en masse to 8½″×11″ paper. Alternatively, all scroller markers may be selected at once and used to print their designated content on the available paper in the associated printer. In this case, some content will fill the paper and other content (like that for a 6″ height printable area) will not.

The invention also includes the use of scroller markers, as produced and described above, to accept assignments of functionality and actions. Thus the markers may have functions, actions, operations, and ordered lists of functions, actions, and operations assigned to them. As shown in FIG. 14, an arrow 37 may be drawn to encircle and select some information displayed in a VDACC or other display presentation, and the arrow is drawn to intersect or lead to a scroller marker; herein, the bottom marker. Thereafter the encircled and selected information (text, data, graphics, pictures, functional objects, actions, etc.) is assigned to the bottom marker. Thereafter, clicking on the bottom marker causes the encircled information to be displayed, or may cause the functional objects to begin their function or action, or the like. Selecting Print for the bottom marker may cause the selected information to be printed.

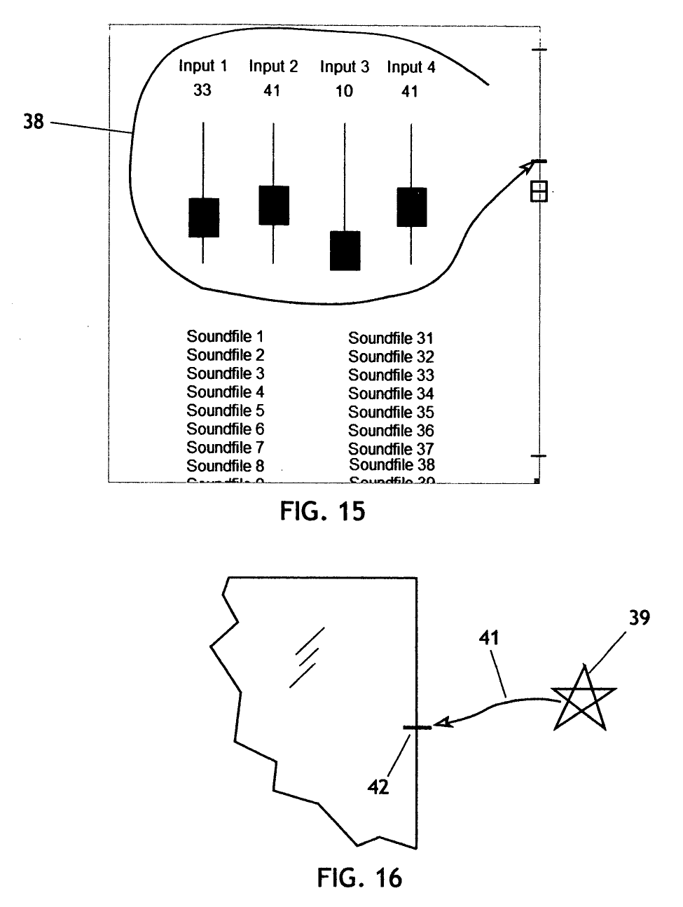

With regard to FIG. 15, in another example of assignment to scroller markers a user may place a list of sound files into a VDACC. The user then places scroller markers along the right side of that VDACC, corresponding to sections of the list that are visible in the VDACC for each scroller marker. Then the user may assign (using an arrow 38 or the like) a functional device, such as an equalizer or echo DSP device to one or more of these scroller markers. The assignment establishes that the device may be applied only to the sound files that lie within the vertical space of the VDACC defined by each respective scroller marker. This assigned relationship enables a user to very quickly equalize or add echo or compression or any number of audio modifications to actual sound files that are named as text in a VDACC. NOTE: In this case, file names given as text represents actual sound files. And the DSP processing assigned to a given scroller marker may be applied to those sound files (represented as a text list) that reside in the area defined and controlled by each scroller marker.

Alternatively, the default result of the assignment of the DSP device to the scroller marker by arrow 38 may be that any click or access to that scroller marker scrolls the display to the DSP device, but the processing is not necessarily applied to the sound files that reside in the area defined by the scroller marker. One technique for setting the interpretation of the assignment action (drawing of an arrow, vocal input, etc.) to a scroller marker is to present a pop up menu for the assignment and give the user a choice among several options: (1) is this simply an assignment to the scroller marker for purposes of navigating to the device when you double click or its equivalent on the scroller marker, or (2) are you applying the device and its function to the scroller marker such that this function can be applied to content that is controlled by that scroller marker. Another way to set the assignment relationship is by the software using context. In other words, if the assignment to the scroller marker is for a device that has no viable application to the content currently controlled by the scroller marker, no action, function or operation assignment will be made and a simple navigational assignment will be made. But a pop up menu may still be needed to enable the user to decide whether to “add” this assignment to an existing content already controlled by the scroller marker or replace it. In other words, a pop up could appear asking the user if he/she wants to “add” or “replace”. Add would signify add the mixer encircled by arrow 38 to the content already controlled by the scroller marker. Or “replace” that content with just the mixer.

It should be noted that scroller markers may be used to modify the content of frames and VDACCs in many ways. These include but are not limited to, changing the properties of this content, modifying the actions of this content, altering the performance or conditions of this contents, changing the structure of this content, applying a list of operations in sequence or in parallel to this content.

The same technique of assignment to scroller markers may be used for all sorts of other operations. For instance, scroller markers may be used to modify pictures, graphics, drawings and other kinds of graphical structures that have been placed into a VDACC and are assigned to and “governed” by a specific scroller marker. A user may simply apply a graphic set of instructions or set of conditions to that scroller marker which will then apply those instructions or conditions to the graphics within the area of the VDACC controlled by that scroller marker. As an example, a user may apply the following to a scroller marker: (1) a functional device (like an equalizer or compressor or mixer), (2) an action (like changing the volume of a sound file by +2 dB). Or, a user may assign a RGB color and/or a contrast, saturation and brightness setting to a scroller marker. Thereafter these properties may be automatically applied to every picture, graphic, etc., within the area of the VDACC that this scroller marker controls. Another assignment technique is to simply drag a DSP device (represented as a graphic with various knobs, faders, joysticks and switches) to intersect a scroller marker, and thereafter that device will automatically be assigned to that scroller marker.

Right clicking on a marker to which a device has been assigned will show this device in a menu (info canvas) belonging to that scroller marker. In this menu, a user may modify the setting(s) of this device to further affect the content that lies within the area of the VDACC controlled by that scroller marker.

The same assignment technique may apply to any modification or function or operation. For instance, a group of photo editing devices that enable a user to adjust the hue, saturation, contrast, blur, rotation and the like for a picture may be dragged to intersect a scroller marker. They would then be assigned to that scroller marker and thereafter may be used to control all of the graphical objects that lie within the VDACC's area controlled by that scroller marker.

Another technique to assign functionality and properties and operations to a scroller marker is to draw a graphic like a line or arrow from the DSP or photo editing or other such graphical device or physical device represented by a graphic, to intersect the scroller marker with the tip of the arrow. Clicking on the tip of the arrow completes the assignment to the scroller marker, or the assignment may occur automatically upon the mouse upclick that completes the assignment arrow.

As described previously, a list of operations can be assigned to a scroller marker. As an example, the computer user turns on a recording method, such as Dyomation, described in U.S. patent application Ser. No. xx/xxx,xxx, titled System And Method For Recording And Replaying Property Changes On Graphic Elements In A Computer Environment. The user simply clicks on various functions or graphics onscreen in a specific order that results in a desired action and records these steps. Then an arrow is drawn from the Dyomation Play switch or its equivalent to point to a scroller marker for a VDACC or frame. Then this sequence of events may be applied to each sound, picture, drawing, graphic, video, animation or other digital media that lies within the area of the VDACC controlled by that marker.

An action, function or operation, etc., assigned to a VDACC scroller marker may be invoked using any one of a variety of techniques. One technique is to right click on a scroller marker to display its Info canvas and select “invoke” in its menu or info canvas. Another technique is to double click on a scroller marker and its assigned function, action, operation, list of operations is thereafter applied to all objects that it controls in the VDACC or frame or its equivalent.

Scroller markers are not limited to use with a VDACC or frame. They can, for instance, be utilized with VDACCs that are in the space of recognized objects or look like free drawn areas of screen space. For instance, a user may create a VDACC that has the shape of a circle or triangle or rectangle or star or heart or any recognized object. Then the user may right click on the circle VDACC, for instance, and select; “scroller markers”. Then a top and bottom scroller marker will appear for that circle. As users typed more text or dragged more objects into the circle VDACC the scrollable vertical height of the VDACC would increase. As the scrollable vertical height of the VDACC increases more and more space becomes available for placing vertical scroller markers. The same rule applies if a user adds more content to the right side of a circle or heart or star shaped VDACC. More and more horizontal space would be created for placing horizontal scroller markers. These markers can be used in the same way as explained above.

As another alternative, a free drawn line that defines some type of enclosed space may have scroller markers and a scrollable area just as the VDACCs. One could think of this line as a free form VDACC. Again, as items are dragging in the vertical and/or horizontal space of this free form VDACC, more and more space is created for placing scroller markers for this object. These scroller markers can be used for any purpose described above.

In a further technique for using scroller markers, a user may assign objects directly to a scroller marker such that actions and functions, etc., that are applied to that scroller marker can be used to modify those objects “assigned” to that scroller marker. To state this another way, the scroller marker would have “control” over the ability to modify the properties or actions or functions, etc., of any object that is has been assigned to it. As shown in FIG. 16, a graphic object such as a star 39 may be assigned to a scroller marker 42 by drawing an arrow 41 from the graphic object to the marker 42. Other methods of making an assignment to a scroller marker may include:
(1) Drag any one or more objects such that they intersect a scroller marker. Then upon a mouse up click or upon the collision detection itself, the assignment is made to the scroller marker.
(2) Touch an object or objects and then touch a scroller marker directly after.
(3) Draw a line or arrow that intersects or encircles one or more objects and then point the line or arrow to the scroller marker.
(4) Use a vocal command: speak “assign star 39 to scroller marker 42.” In this case, scroller markers may be assigned visible numbers as they are created.

The benefit of this technique is user convenience and speed of use. For instance, if a user needed to quickly equalize some audio files, he/she may type them anywhere onscreen and then assign them to a VDACC scroller marker whose function is to apply an audio equalizer to any item that is assigned to it, that is under its control.

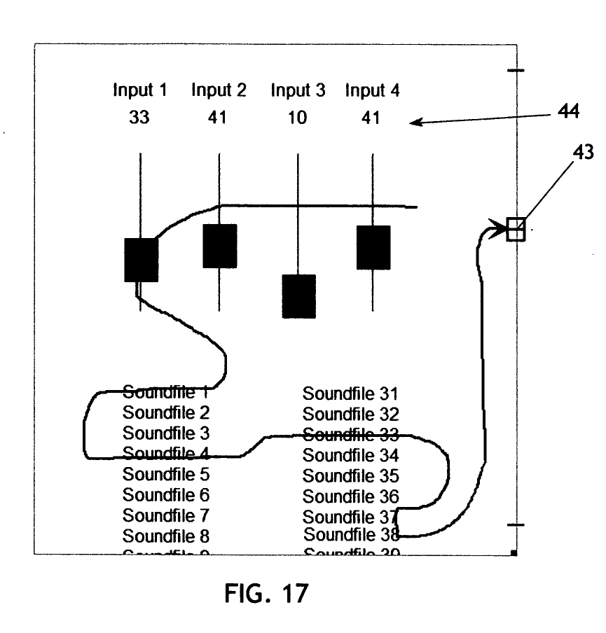

FIG. 17 depicts another example of using an arrow or line to assign objects to a scroller marker. A small audio mixer 44, plus sound file 1, 4, 33, 36 and 38 are assigned to the scroller marker by drawing an arrow that extends through the mixer 44 and the names of the sound files and leads to the scroller cap. Thereafter a scroller marker (43) is placed by double clicking on the scroller cap of a VDACC. Thereafter clicking on marker 43 causes the display to scroll to the area that displays the mixer 44 and the related sound files, and these sound files are preset to be mixed by the device 44. As an alternative the scroller marker can be placed first and then the assignment of various content can be made directly to that scroller maker by various means. These include drawing an arrow that encircles and/or intersects various content and then points to the scroller marker, dragging the content to intersect the scroller marker, lassoing the content to select it and then clicking on the scroller marker, using a vocal command, such as “assign”, wherein certain content is selected and the vocal command is used to assign it. Or the vocal command is used to both select (“select soundfiles 3-8 and 32-35) and assign (“assign these soundfiles to marker 6”) this content to a scroller marker.

It may be noted that other techniques may be employed to place scroller markers on VDACCs and frames. For instance, a user may touch a scroller cap and state a verbal command such as “place marker”. Or, a user may lasso a scroller marker and its VDACC and that automatically places a scroller marker at the position of that scroller cap. The placement of the scroller marker may be centrally located (bisecting the center of the scroller cap) or located at the top or bottom edge of the scroller cap, etc. Another way of placing a scroller marker may be to draw an ellipse around a scroller marker as it sits along the edge of a VDACC. This drawing will cause a scroller marker to be automatically placed for that position of the scroller cap.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiments described are selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In an electronic display having a frame for defining the boundaries of a display area and a scroller fader cap displayed at one edge of said frame and constrained to translate along said one edge to scroll a display within said frame, the improvement comprising:
means for activating said fader cap to place at least one scroller marker on said one edge of said frame, said scroller marker denoting a portion of the display within the frame at the corresponding position of said fader cap;
means associated with said at least one scroller marker for printing only the denoted portion of the display within the frame.

2. The improved electronic display of claim 1, further including a plurality of said scroller markers, each denoting a respective portion of the display within said frame.

3. The improved electronic display of claim 2, wherein said means for printing includes a Print Area On command to activate said scroller markers to print the respective denoted portions of the display in non-contiguous fashion.

4. The improved electronic display of claim 2, wherein said means for printing includes an arrow drawn through selected ones of said plurality of scroller markers and extending to a Print command object displayed onscreen, whereby portions of said display within said frame corresponding to said selected ones of said scroller markers are printed.

5. The improved electronic display of claim 2, wherein each scroller marker may be modified to set a page size and format for printing, whereby each scroller marker may cause the printing of the respective denoted portion in the respective modified page size and format.

6. In an electronic display having a frame for defining the boundaries of a display area and a scroller fader cap displayed at one edge of said frame and constrained to translate along said one edge to scroll a display within said frame, the improvement comprising:
means for activating said fader cap to place at least one scroller marker on said one edge of said frame, said scroller marker denoting a portion of the display within the frame at the corresponding position of said fader cap;
means for assigning at least one component of said denoted portion of the display within the frame to said at least one scroller marker.

7. The improved electronic display of claim 6, wherein said means for assigning includes an arrow drawn from said at least one component to said at least one scroller marker.

8. The improved electronic display of claim 6, wherein said means for assigning includes dragging at least one component to intersect at least one said scroller marker.

9. The improved electronic display of claim 6, wherein said at least one component includes a functional device, whereby clicking on said at least one scroller marker scrolls said display within said frame to present said functional device.

10. The improved electronic display of claim 9, wherein said denoted portion of said display within said frame includes data files operable by said functional device.

11. The improved electronic display of claim 7, wherein said assignment arrow extends through data files displayed within said frame and operable by said functional device, whereby said data files are set to be operated upon by said functional device.

12. In an electronic display having a frame for defining the boundaries of a display area and a scroller fader cap displayed at one edge of said frame and constrained to translate along said one edge to scroll a display within said frame, the improvement comprising:
means for activating said fader cap to place at least one scroller marker on said one edge of said frame, said scroller marker denoting a portion of the display within the frame at the corresponding position of said fader cap;
means for assigning at least one onscreen object outside said frame to said at least one scroller marker.

13. The improved electronic display of claim 12, wherein said means for assigning includes an arrow drawn from said onscreen object to said at least one scroller marker.

14. The improved electronic display of claim 12, wherein said onscreen object outside said frame is selected from the following categories of representative onscreen objects: active devices, actions, operations, properties, and functions.

15. The improved electronic display of claim 14, further including at least one data file within said denoted portion of the display, wherein said means for assigning said onscreen object further enables said onscreen object to operate on said at least one data file within said denoted portion of said frame.

16. The improved electronic display of claim 14 wherein said means for assigning said onscreen object outside said frame further enables said onscreen object to operate on data files outside said denoted portion of said frame.
